(19) United States
(12) Patent Application Publication
(10) Pub. No.: US 2007/0159837 A1
(43) Pub. Date: Jul. 12, 2007

(54) Illuminable information unit

(76) Inventors: Michael Flehinghaus, Reinbeck (DE); Andreas Teitge, Hamburg (DE)

Correspondence Address: WILLIAM COLLARD;COLLARD & ROE, P.C., 1077 NORTHERN BOULEVARD, ROSLYN, NY, 11576, US

(21) Appl. No.: 10/594,877

(22) PCT Filed: Mar. 29, 2005
(86) PCT No.: PCT/EP05/03283

§ 371 Date: Sep. 29, 2006

(30) Foreign Application Priority Data
Mar. 29, 2004 (DE) 10 2004 015 293.4

(51) Int. Cl. B60Q 1/00

(52) U.S. Cl. 362/459

(57) ABSTRACT

The invention relates to the production of an information unit for technical devices and machines, in particular for vehicle accessories which is readable day and night independently of the angle of view. For this purpose, the visible display elements (6) of the information unit comprises at least one light-diffusing plastic element (4) in which transparent and/or colored transparent diffusers are inserted into a transparent and/or colored transparent plastic compound.

The present invention relates to an illuminable information unit for technical apparatus or machines, in particular for a fitting for a vehicle.

Such information units are known in a variety of embodiments, for example in the field of automobiles. Here, it is a question of representing a growing amount of data with regard to the operating condition of the vehicle or on-board installations, by way of optical signal providers or likewise, to the driver.

For example, data on the switched-on condition of a rear window heating, information as to whether the anti-blocking system, the seat heating or the ESP is active, information on the switched condition of various outer lighting units, such as driving light and/or dipped beam or fog light or rear fog lamp is represented in the form of a display.

For reasons of safety, the manufacturers of vehicles demand that the information represented in this manner is well recognisable with daylight as well as at night. In particular, for ensuring safety and comfort, there exists the demand that the displays to the greatest extent are easily read, independently of the viewing angle with a large contrast sharpness.

For example, a light diode is used as a light source with a known display. The light from this light diode is incident onto this scatter lens which expands the light beam in order to increase the illuminated surface and simultaneously to increase the radiation angle. Subsequently, the enlarged light beam is incident onto the inner side of the housing. The housing thereby is provided with an opaque paint on the outer side. Recesses produced by laser are contained in the paint, which for example have the shape of a symbol, such as for the rear window heating or the ABS braking system, or letters. Subsequently, the expanded light beam passes through these recesses, so that the desired symbol or the desired letters appear bright. The disadvantage with this type of display however is the fact that on the one hand, on account of the spatial limitations of the optics, the beam expansion by way of the scatter lens is only insufficiently possible. The disadvantage that the divergence angle of the beam, thus the outward radiation angle is only increased to an inadequate extent, results due to this. Because of this, there results the problem that the display may be recognised without any problem only by observers in a viewing angle range which is essentially parallel to the outward radiation direction of the light source. The display may not be read outside this viewing angle range. This may lead to a compromise of the safety, in particular with display of safety-relevant data, such as for example the switched-on condition of the ESP.

In order to alleviate the problem of the viewing angle which is too small, it has been suggested to supplement the construction described above by way of adding a scatter plate which is placed between the housing of the display and the scatter lens. The light beam expanded by the scatter lens, by way of multiple scattering in the scatter plate is converted to the greatest extent from directed light radiation into diffuse light radiation with the help of this scatter plate. Although the desired widening of the viewing angle may be achieved in this manner, its construction however has a series of disadvantages. On the one hand it is disadvantageous that the development costs are very large, since with the design of the display, limitations on the freedom of design are set due to the complicated construction for the beam expansion. On the other hand, a minimum construction size results from the number of required components, below which one may not fall. Since several components are required, on manufacture and development, one must strictly adhere to tolerances which leads to a further increase in the manufacturing costs. A further disadvantage of the use of a combination of a scatter lens and a scatter plate arranged downstream lies in the fact that in the non-illuminated condition with daylight, the recessed symbols or letters do not have the desired contrast to the paintwork, so that either they are not adequately clearly perceivable, or undesirably appear as if they were switched on, or undesirably have the appearance of being switched-off, depending on the colour of the paint, although no illumination is effected.

It is the object of the present invention to specify an illuminable information unit for technical apparatus or machines, in particular a fitting for vehicles, which is readable day and night independently of the viewing angle, and furthermore may be manufactured particularly inexpensively.

According to the invention, this object is achieved in that the visible display elements of the information unit consist of at least one light-scattering plastic element with which transparent scatter bodies are embedded into a transparent plastic mass.

By way of this, one realises the expansion of the light irradiated away from the light source by way of the scatter in the display element itself. In this manner, one requires neither a scatter lens nor a separate scatter disk, as is the case with the state of the art. Rather, this function is already integrated in the material of which the display element consists. For this reason, by way of the light scattering in the display element, one advantageously succeeds in the display element being able to be read at any viewing angles in the half-space facing the user. The design of the information unit may advantageously be designed in an inexpensive and flexible manner. In particular, one also does not need to take any minimum dimensions into account. An application of an information unit according to the invention in vehicles on land, water or in the air, for the display of various data for operation or interior fittings is particularly advantageous. An application of the information unit according to the invention is also favourable with display panels of devices of consumer electronics, such as televisions, video apparatus or likewise, as well as generally all household apparatus

A further advantage of the information unit according to the invention with the scattering plastic element in particular is the good recognisability during the day as well as the night, even at large viewing angles with respect to the perpendicular to the surface.

According to a particularly preferred design of the invention, the transparent plastic mass is selected form the group of polycarbonates. Polycarbonates have the advantage that they have particular favourable material properties for the injection moulding- and/or extrusion method and all special methods for thermoplastic shaping of plastic. In particular, the impact values at low temperatures as well as the high temperature stability are advantageous. Furthermore, polycarbonates have a particularly suitable processing temperature for injection moulding methods. The mechanical and thermal stability of polycarbonates are particularly advantageous for the use of the material for housing parts of vehicles on land, water and in the air. With the use of polycarbonates as a transparent plastic mass, it has been shown to be particularly advantageous for the scatter properties, for the weight component of the embedded transparent scatter bodies to be 0.0001 to 10%, and for the scatter bodies to have a size of approx. 0.1 μm to 5 μm, preferably 2.5 μm. Furthermore, for achieving an optimal homogenisation of the light with respect to the radiation angle, it is favourable if the size of the scatter bodies has a narrow distribution function, for example a Gauss distribution about one size. Furthermore, mixtures of scatter bodies which have a bi-modal or multi-modal, narrow distribution function, for example a Gauss distribution, have been shown to be particularly well suitable. One furthermore obtains particularly good scatter properties when the inclusions have an essentially spherical shape. On admixing the scatter bodies to the polycarbonate, it has been surprisingly ascertained that in particular the desired mechanical properties of the polycarbonate as well as the known processing behaviour and the volume contraction are retained. The mechanical properties of the polycarbonate are thus advantageously not negatively influenced by the admixture of the scatter bodies.

With a further formation of the information unit according to the invention, the light-scattering plastic element is provided with a cover layer, wherein the cover layer comprises recesses which may for example be produced by way of laser processing. By way of this, one advantageously succeeds in the light scattered in the scatter body exiting the display element in a targeted manner only at the recesses, inasmuch as the cover layer is opaque. On the other hand, with regard to the daylight design, an advantageously high contrast ratio to dark symbols results with the use of bright interior colours. A paint coating is particularly suitable as a cover layer. Alternatively, the mentioned advantageous properties may also be retained if the light-scattering plastic element is only provided with the cover layer at regions which with regard to the surface, correspond to the mentioned recesses. By way of this, one succeeds in the light scattered in the scatter body exiting in a targeted manner only at the recesses and not out of the display element. In this manner, one may represent information which is inverted with respect to the contrast. In this manner the display element by daylight appears dark against the bright background of the cover layer or paint layer, corresponding to an advantageously high contrast value. The light energy emitted by the light source remains in its sum without being absorbed, and is only converted into diffuse light radiation with respect to the light radiation direction, by way of the scattering at the scatter bodies in the inside of the polycarbonate.

With an alternative formation of the invention, the cover layer has a dark colour impression. In this manner, analogously to the procedures described in the preceding section, one may advantageously achieve a particularly low contrast between the display element and the cover layer or the paint layer. This leads to the fact that the display during daylight and in the non-illuminated condition appears essentially uniformly dark, and the recessed symbols and/or letters are not recognisable. These are advantageously only recognisable on switching on the light source.

A particularly compact constructional manner results if the plastic element is integrated into an operating element. For example, the information unit may be integrated within a button as a display, and optically display the switched condition of the button.

One obtains an even more compact constructional manner if the plastic element itself is already designed as an operating element. In this manner, advantageously, for example the use of an additional scatter disk is done away with, since the functions of the light scattering, the display of the desired information as well as the switch function of the button are all unified into one component. Thereby, it is particularly advantageous if the button consists of polycarbonate, since polycarbonate is advantageous with respect to the impact strength at low temperatures and with respect to the thermal stability, in particular for applications in the field of automobiles.

One special design of the invention envisages the information unit being designed as a combination instrument or display within this. In this manner, with regard to the tachometer information which is particularly relevant with regard to safety, it is ensured that this may be read independently of the viewing angle.

One variant of the invention is characterised in that the light-scattering plastic element is designed as a light distributor and/or light guide within the information unit. By way of the use of the plastic element as a light guide, in particular with the use of LEDs as light sources, these may be reduced with regard to their numbers, which advantageously leads to a reduction of the costs for the information unit. Thereby, one utilises the fact that by way of the scatter, a homogenisation of the emitted light is achieved in a manner such that the locations of individual LEDs are not recognisable from the outside, since the display is uniformly illuminated over the whole surface. The surface illuminated by a single LED may essentially extend over the complete surface of the display on account of the light-scattering plastic element; the light is thus advantageously distributed over the whole display. In this manner, several locations of the display may be illuminated with only one LED. This embodiment is also suitable as a multi-dimensional light guide of a light source proceeding in any spatial direction.

Preferred embodiments of the invention are hereinafter explained in more detail by way of the drawings.

The figure individually show in:

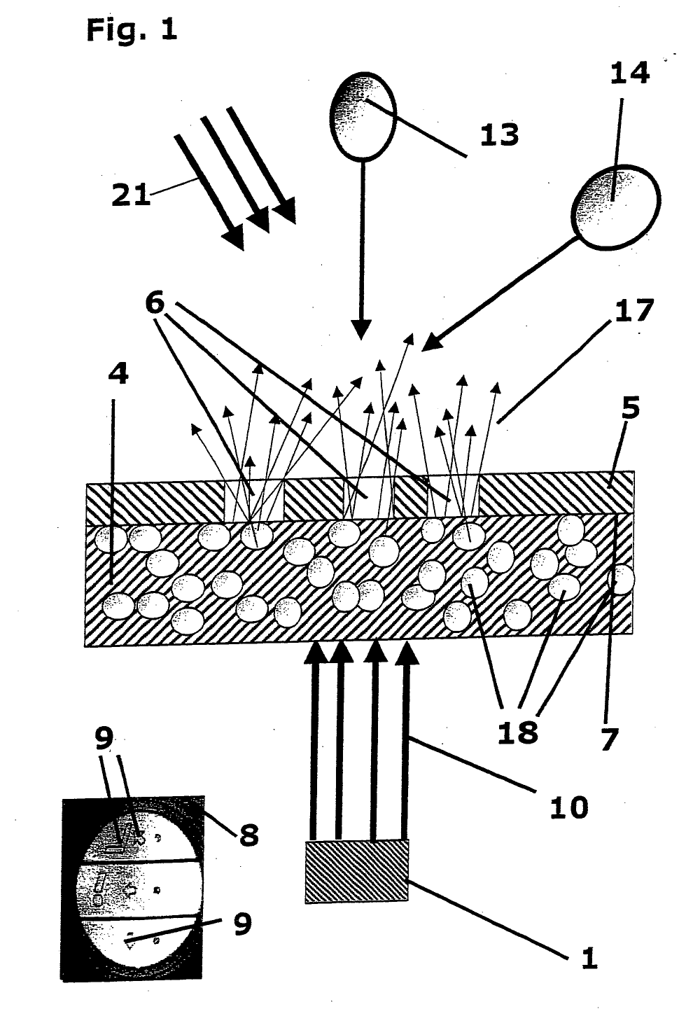

FIG. 1: a button according to the invention with an intrinsic light scatter characteristic and LED,

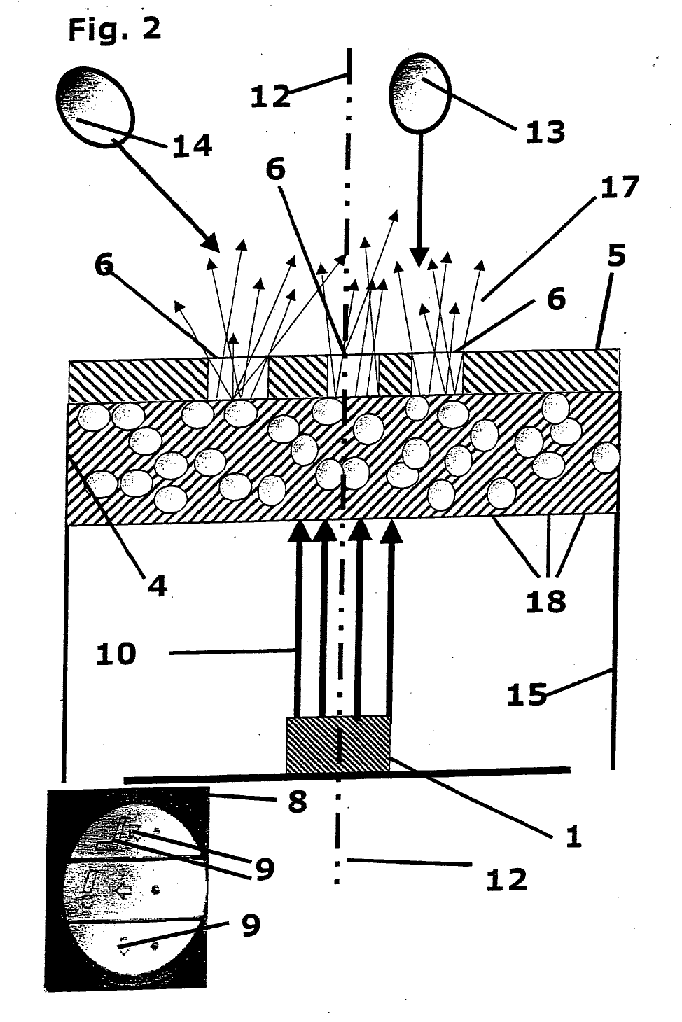

FIG. 2: a schematic representation of the manner of functioning of a display unit according to the invention,

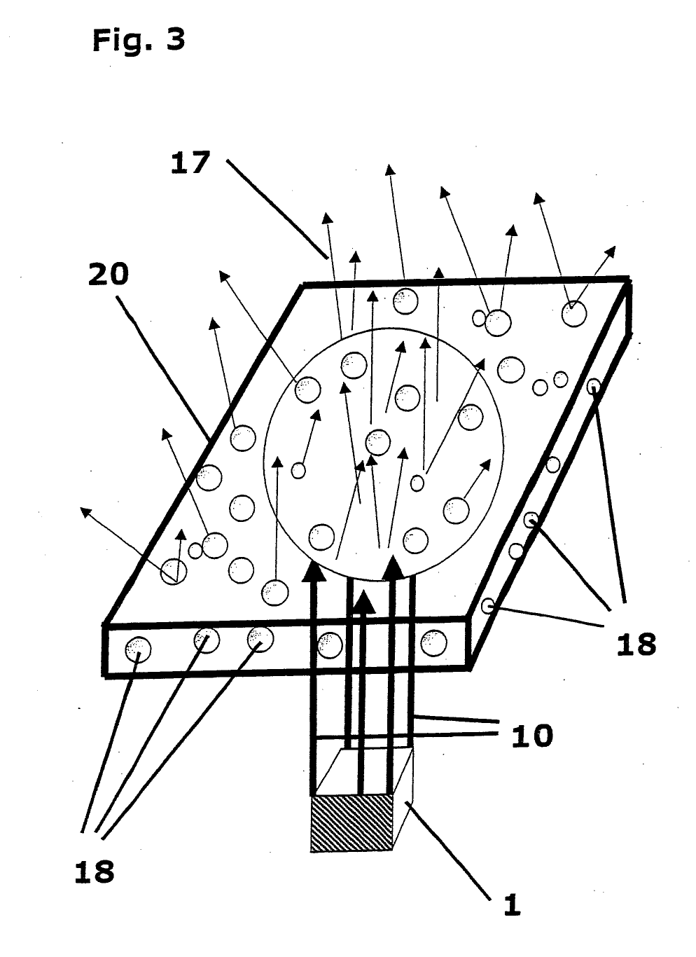

FIG. 3: a schematic representation for the illustration of the light-guiding property of a display unit according to the invention,

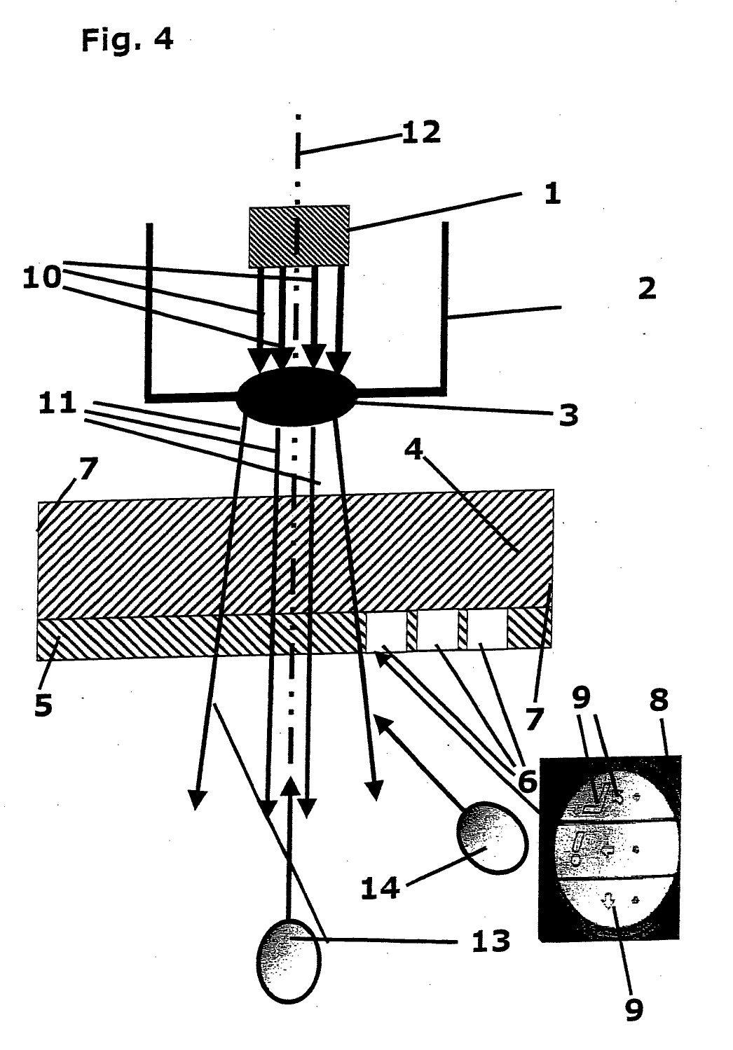

FIG. 4 a schematic representation of a display according to the state of the art,

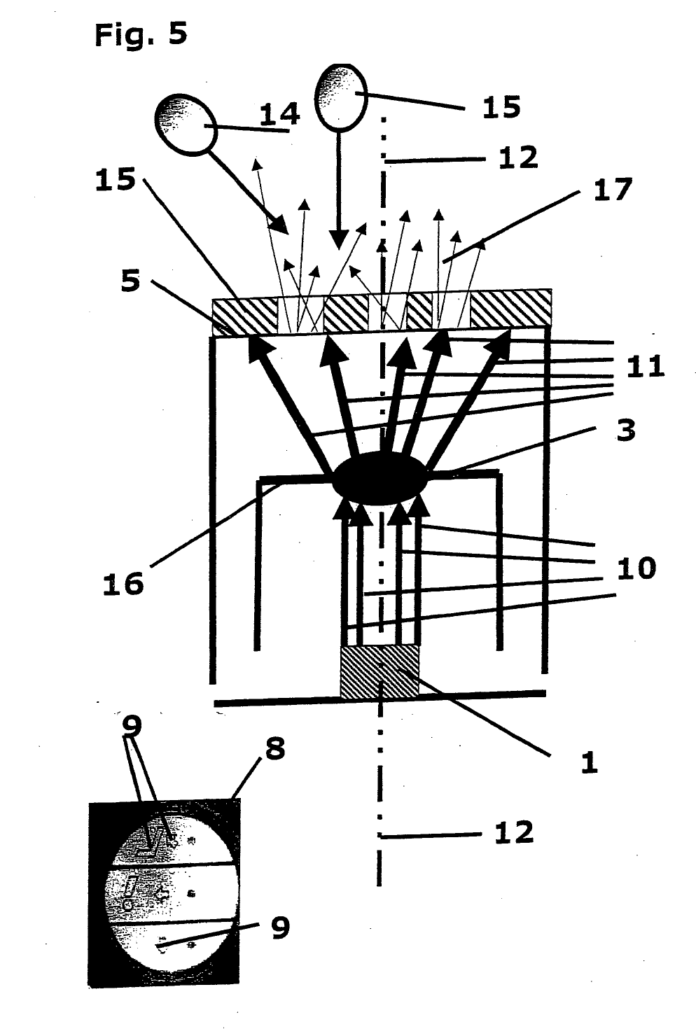

FIG. 5 a schematic representation of a display according to a complicated, cost-intensive manner of an improved state of the art,

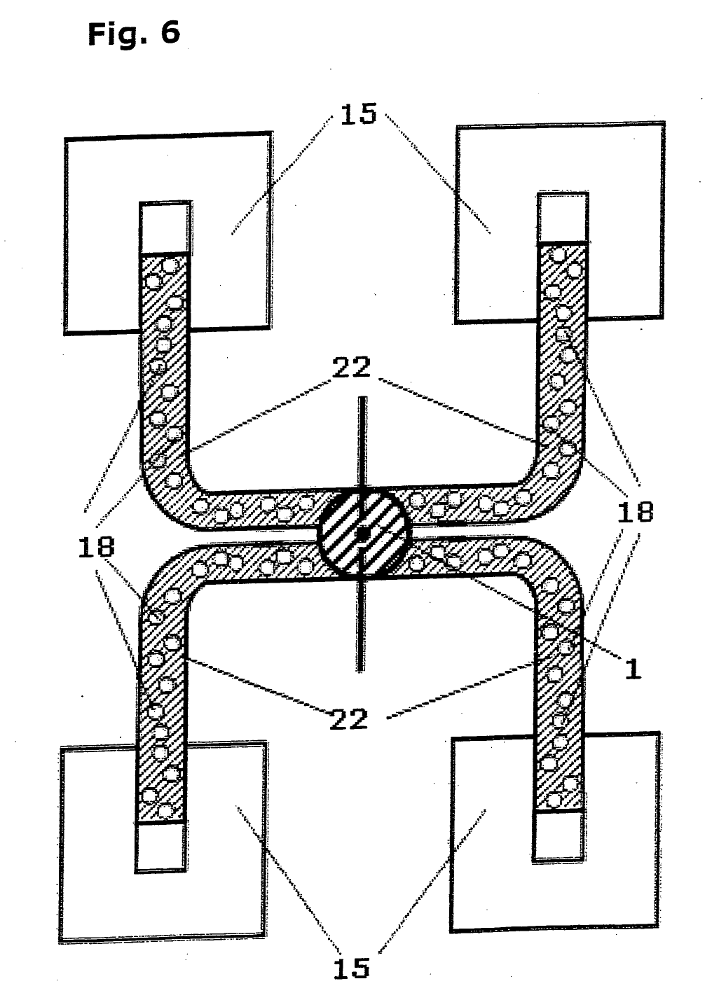

FIG. 6 a plan view of a multi-dimensional light guide according to the invention,

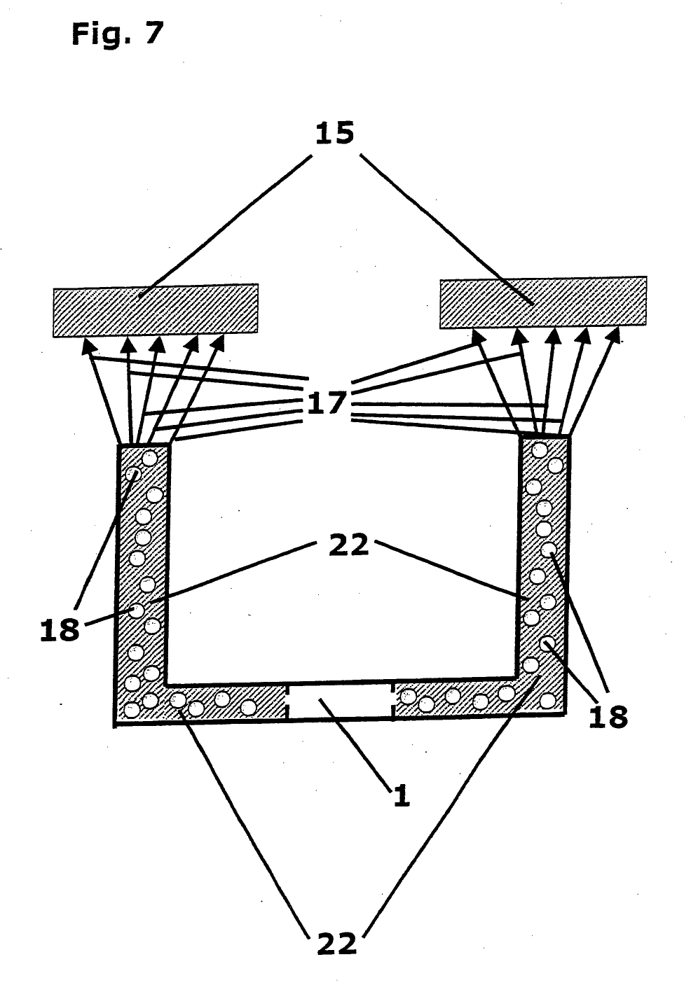

FIG. 7 a lateral view of the multi-dimensional light guide according to the invention, of FIG. 6,

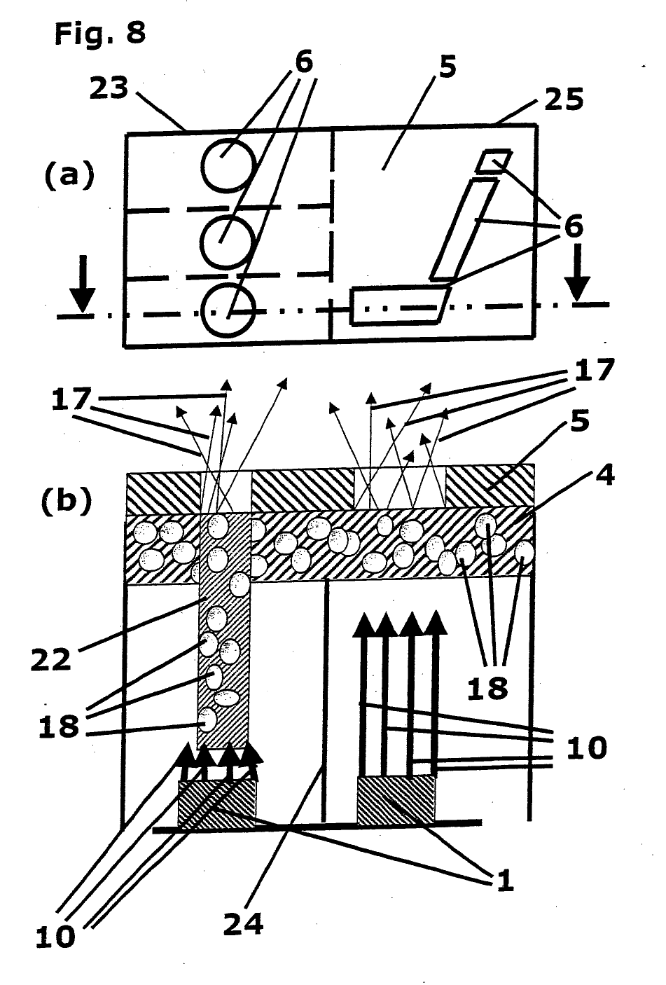

FIG. 8 an application example of a multi-dimensional light guide according to the invention.

Firstly, a display unit corresponding to the state of the art is represented schematically in FIG. 4. The display unit consists of a light diode 1, of a light diode housing 2, of a scatter lens 3 as well as a display housing 4. The display housing 4 is coated with an opaque paint layer 5. The opaque paint layer 5 has recesses 6 at which in each case a housing outer side 7 of the display housing 4 is set free. The regions of the housing outer side 7 set free by the recesses 6 form visible symbols in the plan view 8 against the background of the opaque paint layer 5. As may be further deduced from FIG. 4, the light radiation 10 emitted by the light diode 1 is essentially bundled and therefore is approximately incident onto the scatter lens 3 attached in the light diode housing 2. The light radiation 11 which is slightly expanded by the scatter lens 3 has a somewhat larger angle of divergence than the emitted light radiation 10 and is incident onto the display housing 4. The slightly expanded light radiation exits the display through the symbols 9 formed by the recesses 6 in the paint layer 5, onto an observer 13 viewing in the direction of the optical axis 12. The expanded light radiation 11 is not incident onto an observer 14 viewing at an angle of approx. 45° to the optical axis 12, so that the observer 14 is not capable of recognising the symbols 9 which illuminate [through].

According to one variant of the state of the art, a button 15 with an integrated display unit is represented in FIG. 5. A light diode 1 may be recognised, from which the emitted light radiation 10 exits. The emitted light radiation 10 is incident onto a scatter lens 3. The light radiation 11 expanded by the scatter lens 3 further goes through a button scatter disk 16, by way of which the expanded light radiation 11 is converted into diffuse light radiation 17 by way of multiple scattering within the button scatter disk 16. The diffuse light radiation 17 is incident onto the button 15 provided with an opaque paint layer 5. Diffuse light radiation 17 goes through recesses 6 in the paint layer 5 appearing in the plan view 8 as symbols 9, onto a observer 13 viewing in the direction of the optical axis 12, as well on an observer 14 viewing at an angle of approx. 45° to the optical axis. On account of the diffuse light radiation 17, the symbols 9 in the plan view may thereby be recognised to the same extent by the observer 13 viewing in the direction of the optical axis, and by the observer 14 viewing at an angle of approx. 45° to the optical axis 12. The interaction of the scatter lens 3 with the button scatter disk 16 is however required for this, wherein these components must be arranged at a certain distance to one another. The construction becomes complex and cost-intensive due to this.

A display unit according to the invention is shown in FIG. 1. Again, a light diode 1 may be recognised which emits the directed, emitted light radiation 10. The directed, emitted light radiation 10 parallel to the optical axis 12 is incident directly onto the display housing 4. The display housing 4 consists of polycarbonate into which the transparent scatter bodies 18 are embedded. The housing outer side 7 is covered with the opaque paint layer 5 which has a bright colour and in which the recesses 6 are located, which in the plan view 8 form the symbols 9. The directed, emitted light radiation 10 in the inside of the display housing 4 is converted into diffuse light radiation 17 by way of multiple scattering at the transparent scatter bodies 18. The diffuse light radiation 17 goes through the recesses 6 which are incorporated in the paint layer 5 and which form the symbols 9 in the plan view, onto an observer 13 viewing in the direction of the optical axis 12, and onto an observer 14 viewing at an angle of approx. 45° to the optical axis 12.

On account of the diffuse light radiation 17, the symbols 9 in the plan view 8 thereby may be advantageously recognised to the same extent by the observer 13 viewing in the direction of the optical axis 12, and by the viewer 14 viewing at an angle of approx. 45° to the optical axis 12. This advantageous effect is thereby surprisingly achieved with merely one component which per se fulfils the functions of a scatter lens 3, a button scatter disk 16 as well as a display housing 4.

If the light diode 1 in FIG. 1 is not switched on, in the plan view 8, the symbols 9 represented by the recesses 6 incorporated in the paint layer 5 appear essentially dark on account of the contrast ratio. The symbols 9 in the switched-off condition of the light diode 1 with incident daylight 21 appear in a coloured contrast to the bright paint layer 5 on account of this.

By way of this, one succeeds in the symbols being able to be recognised to the same extent by the observer 13 viewing in the direction of the optical axis 12 as well as by the viewer 14 viewing at an angle of approx. 45° to the optical axis 12, even with daylight.

According to the invention, the housing outer side 7 may be covered to the same extent with an opaque paint layer 5 which has a dark colour and in which the recesses 6 are located, which form the symbols 9 in the plan view 8. In this case too, the directed, emitted light radiation 10 in the inside of the display housing 4 is converted into diffuse light radiation 17 by way of multiple scattering at the transparent scatter bodies 18. The diffuse light radiation 17 again goes through the recesses 6 which are incorporated in the paint layer 5 and which form the symbols 9 in the plan view 8, onto an observer 13 viewing in the direction of the optical axis 12 and onto an observer 14 viewing at an angle of approx. 45° to the optical axis 12.

On account of diffuse light radiation 17, in the case of a dark paint layer 65, the symbols 9 may be advantageously recognised to the same extent by the observer 13 viewing in the direction of the optical axis 12, and by the observer 14 viewing at an angle of approx. 45° to the optical axis 12.

If in contrast, in the case of a dark paint layer, the light diode 1 in FIG. 1 is not switched on, in the plan view 8, the symbols 9 represented by the recesses 6 incorporated in the paint layer 5 are essentially not recognisable on account of the low contrast ratio between the paint layer and the recesses 6 which are not illuminated by the light diode 1. The symbols 9 in the switched-off condition of the light diode 1 given an incident daylight 21 thus hardly appear in any contrast to the dark paint layer 5 on account of this. The symbols 9 are practically not recognisable with daylight 21 and the light diodes 1 not switched on.

In this manner, in each case two conditions inverse to one another may be achieved by day or by night by way of a suitable selection of the combination of a dark or bright paint layer 5 with a switched on or switched-off condition of the light diode 1. The paint layer should thus be selected dark (small contrast between the symbol 9 and the paint layer 5 with a switched-off light diode 1) or bright (large contrast between the symbol 9 and the paint layer 5 with a switched-off light diode 1), depending on whether for example one wishes a symbol 9 to be particularly well recognisable or practically not recognisable with daylight 21 and with a switched-off light diode.

One embodiment of a further formation of the invention is represented in FIG. 2. As may be recognised in the Figure, the light diode 1 is located in the inside of the button 15 with an integrated display. The light diode 1 emits the light radiation 10. The emitted light radiation 10 is essentially directed and is incident onto the inner side of the display housing 4. The display housing 4 consists of polycarbonate, in which the transparent scatter bodies 18 are embedded. The housing outer side 7 is covered with the opaque paint layer 5 in which the recesses 6 are located, which in the plan view 8 form the symbols 9. The directed, emitted light radiation 19 in the inside of the display housing 4 is converted into diffuse light radiation 17 by way of multiple scattering at the transparent scatter bodies 18. The diffuse light radiation 17 goes through the recesses 6 which are incorporated in the paint layer 5 and which form the symbols 9 in the plan view 8, onto the observer 13 viewing in direction of the optical axis 12, and onto the observer 14 viewing at an angle of approx. 45° to the optical axis 12.

On account of the diffuse light radiation 17, the symbols 9 in the plan view 8 may be advantageously recognised to the same extent by the observer 13 viewing in the direction of the optical axis 12, and by the observer 14 viewing at an angle of approx. 45° to the optical axis 12. Thereby, the display unit 4 is shaped and arranged in a manner such that at the same time, it forms the button 15 itself. This advantageous effect is thereby achieved in a surprisingly simple manner with only one component, which per se unifies the functions of a scatter lens 3, a button scatter disk 16 as well as a display housing 4 and additionally that of a button 15.

If the light diode 1 of the button 15 represented in FIG. 2 is not switched on, in the plan view 8, the symbols 9 represented by the recesses 6 incorporated in the paint layer 5 appear essentially dark on account of the diffuse scattering of the daylight 21 incident from the outside. The symbols 9 in the switched-off condition of the light diode 1 given an incident daylight 21 appear in a coloured contrast to the bright paint layer 5 on account of this.

By way of this, one advantageously succeeds in the symbols being recognised to the same extent by the observer 13 viewing in the direction of the optical axis 12, as well as the observer 14 viewing at an angle of approx. 45° to the optical axis 12, even with daylight.

Finally, a further advantageous embodiment example according to the present invention is represented schematically in FIG. 3. As is to be recognised in FIG. 3, the light radiation 10 emitted from the light diode 1 and which is essentially directed, is incident onto the plate 20. The plate 20 consists of polycarbonate into which transparent scatter bodies 18 are embedded. In the inside of the plate 20, the directed, emitted light radiation 10 is converted into diffuse light radiation 17 by multiple scattering at the transparent scatter bodies 18. The diffuse light radiation 17 exits from the complete outer surface of the plate 20 over a larger area. The diffuse light radiation thereby has a significantly greater expansion than the cross-sectional area of the emitted light radiation 10. In this manner, the light has been expanded over a multiple of the cross section of the emitted light radiation by way of the illumination of the plate 20 which is consists of possibly transparently coloured polycarbonate, with the light radiation 10 emitted over a small area, wherein possibly transparently coloured transparent scatter bodies 18 are embedded into the polycarbonate.

The plate 20 of possibly transparently coloured polycarbonate thus distributes the light and this acts as a light distributor. The light of a single light diode 1 may with this arrangement be advantageously and surprisingly applied for example for illuminating several spatially distributed display symbols 9. Furthermore, also a covering with surface shaped infinitely in all three spatial direction may for example be illuminated with only one or few light diodes 1 with this arrangement. This is of particular interest for safety functions such as for example a warning light attached to a car door, with which other traffic participants may be warned of the open door, wherein preferably the operating comfort for the vehicle driver is increased.

A light diode 1 is to be recognised in FIG. 6 and FIG. 7, which is arranged for illumination of a light guide 22. The light guide 22 consists of possibly transparently coloured polycarbonate, into which possibly transparently coloured, transparent scatter bodies 18 are embedded. The light emitted by the light diode 1 is transported to four buttons 15 by way of multiple scattering at the possibly transparently coloured, transparent scatter bodies 18 within the light guide 22 consisting of possibly transparently coloured polycarbonate. Diffuse light radiation 17 exits at the ends of the light guide and is incident onto the buttons 15 over a large area. Advantageously, the four buttons 15 are in each case illuminated over a large area with one and the same light diode 1 by way of this arrangement. The leading of the light thereby is effected in the horizontal direction—as may be recognised particularly well in FIG. 6—as well as in the vertical direction as may be recognised particularly well in FIG. 7. In this manner, a multi-dimensional light guide is surprisingly suggested, with which for example several spatially distributed display symbols 9 may be illuminated.

Finally one design of the information unit according to the invention as a status display for a vehicle seat heating is schematically represented in FIG. 8. This is to be recognised in the plan view in part a) of the figure. Thereby, the symbol 9 of a seat is represented in the right section of the status display by way of recesses 6 in the opaque paint layer 5. Rectangular recesses 6 as a status display for the seat heating segments is to be recognised in the left section 23. In part b) of the figure, which is a section through the status display of part a) of the figure, further light diodes 1 are to be recognised, which emit essentially directed light radiation 10. Thereby, an individual light diode 1 is allocated to each recess 6 in the left segment 23 of the status display. These are optically separated from one another by an opaque separating wall 24. The essentially directed light radiation 10 of each light diode in the left section 23 of the status display enters a light guide 22 allocated separately to each recess 6 of the left section 23 of the status display. The light guides 22 consist of possibly transparently coloured polycarbonate with embedded, possibly transparently coloured transparent scatter bodies 18. The exit of each light guide 22 in each case runs into a one of the recesses 6 of the status display for the seat heating. The symbols of the status display thereby are selectively illuminated by light which as been emitted exclusively from the light diode 1 allocated to the respective recess, since the directed light radiation 10 essentially only enters the light guide 22 allocated to the light diode. Diffuse radiation 17 exits at the upper end of each light guide 22 by way of the multiple scatter of the directed radiation 10 being effected within each light guide 22 at the transparent scatter bodies 18. In this manner, each recess 6 may be selectively switched on or off separately, and an illumination of the complete surface of each recess 6 is simultaneously possible, although this surface is greater than the cross-sectional surface of the radiation 10 emitted essentially in a directed manner.

In contrast, the directed light radiation 10 in the right section 25 of the status display of the light diode 1 arranged in this section is incident onto the display housing 4 consisting of possibly transparently coloured polycarbonate with embedded, possibly transparently coloured, transparent scatter bodies 18. There, it is converted into diffuse light radiation 17 by the scattering at the transparent scatter bodies 18. The diffuse light radiation 17 of the one light diode 1 completely illuminates symbol 9 of a seat, which is represented in the right section 25 of the status display by the recesses 6 in the opaque paint layer 5. Thus thanks to the invention, with one light diode 1 only may completely illuminate the symbol 9 of a seat, composed of several recesses 6, in the right section.

### LIST OF REFERENCE NUMERALS

1 light diode
2 light diode housing
3 scatter lens
4 display housing
5 paint layer
6 recesses
7 housing outer side
8 plan view
9 symbols
10 emitted light radiation
11 expanded light radiation
12 optical axis
13 observer
14 observer
15 button
16 button scatter disk
17 diffuse light radiation
18 transparent scatter body
19 inner side of the display housing
20 plate
21 daylight
23 light guide
23 left section
24 Optical separating wall
25 right section

1. An illuminable information unit for technical apparatus or machines, in particular for fittings for vehicles, wherein visible display elements (4) of the information unit consist of at least one light-scattering plastic element (4), with which transparent scatter bodies (18) are embedded into a transparent plastic mass (4).

2. An illuminable information unit according to claim 1, wherein the transparent plastic mass (4) and/or the transparent scatter bodies (18) is/are transparently coloured.

3. An illuminable information unit according to claim 1, wherein the transparent plastic mass (4) is selected from the group of polycarbonates and/or from the group of flame-proof and/or high-temperature-resistant polycarbonates.

4. An illuminable information unit according to claim 1, wherein the light-scattering plastic element (4) is provided with a cover layer (5), wherein the cover layer (5) comprises recesses (6) which may be produced preferably by way of laser processing.

5. An illuminable information unit according to claim 1, wherein parts of the light-scattering plastic element (4) are provided with a cover layer (5).

6. An illuminable information unit according to claim 4, wherein the cover layer (5) has a bright colour.

7. An illuminable information unit according to claim 4, wherein the cover layer (5) has a dark colour.

8. An illuminable information unit according to claim 1, wherein the light-scattering plastic element (4) is integrated into an operating element (15).

9. An illuminable information unit according to claim 1, wherein the light-scattering plastic element (4) is designed as an operating element (15).

10. An illuminable information unit according to claim 1, wherein the information unit is designed as a combination instrument and/or display within the combination instrument.

11. An illuminable information unit according to claim 1, wherein the light-scattering plastic element (4) is designed as a single- or multi-dimensional light distributor (20) within the information unit.

12. An illuminable information unit according to claim 1, wherein it is designed as a cover having a three-dimensional surface structure.

13. An illuminable information unit according to claim 1, wherein it is designed as a warning light, in particular for an opened vehicle door, wherein preferably the operating comfort is increased.
